(19) United States
(12) Patent Application Publication
(10) Pub. No.: US 2013/0123397 A1
(43) Pub. Date: May 16, 2013

(54) CRYSTALLINE RESIN COMPOSITION

(71) Applicants: Takeshi Suwa, Funabashi-shi (JP); Hisato Hayashi, Funabashi-shi (JP); Masaaki Ozawa, Funabashi-shi (JP)

(72) Inventors: Takeshi Suwa, Funabashi-shi (JP); Hisato Hayashi, Funabashi-shi (JP); Masaaki Ozawa, Funabashi-shi (JP)

(73) Assignee: NISSAN CHEMICAL INDUSTRIES, LTD., Tokyo (JP)

(21) Appl. No.: 13/811,725

(22) PCT Filed: Jul. 22, 2011
(86) PCT No.: PCT/JP2011/066721

§ 371 Date: Jan. 23, 2013

(30) Foreign Application Priority Data
Jul. 23, 2010 (JP) 2010-166059
Mar. 9, 2011 (JP) 2011-051643

(51) Int. Cl. C08K 5/17; C08K 5/3447

(52) U.S. Cl. CPC C08K 5/175; C08K 5/3447
USPC 524/94; 524/200; 252/182.14; 556/118; 548/402

(57) ABSTRACT

It is an object to provide a nucleating agent that is suitable for promoting crystallization of a crystalline resin and is derived from a natural product, in order to improve the moldability and the heat resistance of crystalline resins such as a poly(lactic acid) resin and a polyolefin resin; and to provide a crystalline resin composition including the nucleating agent. There is provided a crystalline resin composition including a crystalline resin and an amino acid metal salt; and a nucleating agent including the amino acid metal salt.

### TECHNICAL FIELD

The present invention relates to a crystalline resin composition and, in particular, relates to a crystalline resin composition including an amino acid metal salt as a nucleating agent. The present invention also relates to a nucleating agent used for a crystalline resin and a method for producing the amino acid metal salt.

### BACKGROUND ART

Crystalline resins, specifically, a poly(lactic acid) resin that is a biodegradable polyester resin is expected to be used as a packing material such as a container and a film, a fiber material for clothing, floor mats, automobile interior parts, and others, and a material for forming casings and parts of electrical and electronic products. A polyolefin resin is widely used, for example, as various industrial parts such as housing materials and automobile interior and exterior parts and, in particular, has been increasingly used as automobile interior and exterior parts such as a bumper, an instrument panel, a door trim, and a pillar.

In order to improve moldability and heat resistance of the crystalline resins such as a poly(lactic acid) resin and a polyolefin resin, attempts to increase crystallization speed and crystallinity of the resin have been made. For example, a method of adding a nucleating agent is known as one of the methods for increasing crystallization speed and crystallinity of the resin. The nucleating agent serves as a primary crystalline nucleus of a crystalline polymer to promote crystal growth, and as a result, provides a function of reducing the crystal size and increasing the crystallization speed.

Examples of the disclosed nucleating agent for a poly(lactic acid) resin include inorganic particles including talc and/or boron nitride having a certain particle diameter or less, an amide compound having a particular formula, a sorbitol derivative having a particular formula, a metal phosphate and a basic inorganic aluminum compound, and a metal phosphonate. In addition, Patent Document 1 describes that a particular amino acid is effective as the nucleating agent for a poly(lactic acid) resin.

Examples of the developed nucleating agent for a polyolefin include a metal carboxylate such as sodium benzoate, aluminum 4-tert-butylbenzoate, sodium adipate, and sodium bicyclo[2.2.1]heptane-2,3-dicarboxylate; a metal phosphate such as sodium bis(4-tert-butylphenyl)phosphate and sodium 2,2′-methylenebis(4,6-di-tert-butylphenyl)phosphate; a polyhydric alcohol compound such as dibenzylidene sorbitol, bis(methylbenzylidene)sorbitol, and bis(dimethylbenzylidene)sorbitol; and an aromatic phosphonic acid, an aromatic phosphorous acid, and metal salts of them.

### RELATED ART DOCUMENTS

### Patent Document

Patent Document 1: Japanese Patent Application Publication No. 2006-282940 (JP 2006-282940 A)

### SUMMARY OF THE INVENTION

### Problem to be Solved by the Invention

As described above, the method using a nucleating agent can increase a crystallization speed and improve the crystallinity of a molded product. There has been a demand for the development of a more effective nucleating agent in order to achieve higher moldability and higher heat resistance in recent years.

In particular, in order to more effectively use the characteristics of a poly(lactic acid) resin, which is biodegradable and is derived from biological materials, for example, and to protect the natural environment, the nucleating agent is desired to be a material derived from a natural product.

However, few nucleating agents including a material derived from a natural product have been developed until now. In the invention described in Patent Document 1, a carboxy group derived from an amino acid may cause the hydrolysis of a polyester resin.

Therefore, in order to improve the moldability and the heat resistance of crystalline resins such as a poly(lactic acid) resin and a polyolefin resin, the present invention has an object to provide a nucleating agent that is suitable for promoting crystallization of a crystalline resin and is derived from a natural product and a crystalline resin composition including the nucleating agent. The present invention has another object to provide a preferred method for producing an amino acid metal salt that is used as the nucleating agent.

### Means for Solving the Problem

The inventors of the present invention have carried out intensive studies in order to solve the problems, and as a result, have found that, by adopting an amino acid metal salt as a nucleating agent, a nucleating agent achieving not only an excellent crystallization speed but also a small burden on the environment, and a crystalline resin composition containing the nucleating agent can be obtained, thus the present invention has been accomplished.

The inventors of the present invention have also found that, in the production of the amino acid metal salt, by reacting an amino acid with a metal salt, a metal oxide, or a metal hydroxide in an amount more than an equivalent amount of carboxy group of the amino acid, the obtained metal salt can have a higher activity as the nucleating agent.

That is, the present invention relates to, as a first aspect, a crystalline resin composition including a crystalline resin and an amino acid metal salt.

As a second aspect, the present invention relates to the crystalline resin composition according to the first aspect, in which the amino acid metal salt is a metal salt of an amino acid having an aromatic group.

As a third aspect, the present invention relates to the crystalline resin composition according to the first aspect or the second aspect, in which the amino acid metal salt is a metal salt of an α-amino acid.

As a fourth aspect, the present invention relates to the crystalline resin composition according to the second aspect, in which the amino acid metal salt is a tryptophan metal salt.

As a fifth aspect, the present invention relates to the crystalline resin composition according to any one of the first aspect to the fourth aspect, in which the metal species of the amino acid metal salt is at least one selected from the group consisting of lithium, sodium, potassium, magnesium, calcium, barium, aluminum, manganese, iron, cobalt, copper, nickel, zinc, silver, and tin.

As a sixth aspect, the present invention relates to the crystalline resin composition according to the fifth aspect, in which the metal species of the amino acid metal salt is zinc.

As a seventh aspect, the present invention relates to the crystalline resin composition according to any one of the first aspect to the sixth aspect, in which the crystalline resin is a polyester resin,

As an eighth aspect, the present invention relates to the crystalline resin composition according to the seventh aspect, in which the crystalline resin is a poly(lactic acid) resin.

As a ninth aspect, the present invention relates to the crystalline resin composition according to any one of the first aspect to the sixth aspect, in which the crystalline resin is a polyolefin resin.

As a tenth aspect, the present invention relates to the crystalline resin composition according to the ninth aspect, in which the crystalline resin is a polypropylene resin.

As an eleventh aspect, the present invention relates to a nucleating agent for a crystalline resin, the nucleating agent including an amino acid metal salt.

As a twelfth aspect, the present invention relates to the nucleating agent according to the eleventh aspect, in which the amino acid metal salt is a metal salt of an amino acid having an aromatic group.

As a thirteenth aspect, the present invention relates to the nucleating agent according to the eleventh aspect or the twelfth aspect, in which the amino acid metal salt is a metal salt of an α-amino acid.

As a fourteenth aspect, the present invention relates to the nucleating agent according to the twelfth aspect, in which the amino acid metal salt is a tryptophan metal salt.

As a fifteenth aspect, the present invention relates to the nucleating agent according to any one of the eleventh aspect to the fourteenth aspect, in which the metal species of the amino acid metal salt is at least one selected from the group consisting of lithium, sodium, potassium, magnesium, calcium, barium, aluminum, manganese, iron, cobalt, copper, nickel, zinc, silver, and tin.

As a sixteenth aspect, the present invention relates to the nucleating agent according to the fifteenth aspect, in which the metal species of the amino acid metal salt is zinc.

As a seventeenth aspect, the present invention relates to a method for producing an amino acid metal salt, the method being characterized by including reacting an amino acid (a) with a metal salt, a metal oxide, or a metal hydroxide (b) in an amount more than an equivalent amount of carboxy group of the amino acid.

As an eighteenth aspect, the present invention relates to the production method according to the seventeenth aspect, characterized in that the amino acid (a) is reacted with the metal salt, the metal oxide, or the metal hydroxide (b) in a solvent, in which the metal salt, the metal oxide, or the metal hydroxide (b) is poorly soluble.

As a nineteenth aspect, the present invention relates to the production method according to the seventeenth aspect or the eighteenth aspect, characterized in that the metal salt, the metal oxide, or the metal hydroxide (b) and the amino acid (a) that are reaction materials are reacted in a molar equivalent ratio of 100:0.01 to 100:90.

As a twentieth aspect, the present invention relates to the production method according to any one of the seventeenth aspect to the nineteenth aspect, in which the metal species of the metal salt, the metal oxide, or the metal hydroxide (b) is zinc.

As a twenty-first aspect, the present invention relates to the production method according to the twentieth aspect, in which the metal salt, the metal oxide, or the metal hydroxide (b) is zinc oxide.

As a twenty-second aspect, the present invention relates to an amino acid metal salt composition including the amino acid metal salt and a surplus metal salt, a surplus metal oxide, or a surplus metal hydroxide produced by the production method as described in any one of the seventeenth aspect to the twenty-first aspect.

### Effects of the Invention

According to the present invention, by adding an amino acid metal salt as a nucleating agent into a crystalline resin, it is possible to increase crystallization speed and crystallinity of the crystalline resin and to provide a crystalline resin composition that has excellent heat resistance and moldability.

An amino acid is a component of protein and is biodegradable. Thus, the amino acid metal salt used in the present invention is a biodegradable nucleating agent. Accordingly, in the crystalline resin composition of the present invention in which the amino acid metal salt is added to a biodegradable resin such as a poly(lactic acid) resin, not only the resin but also the nucleating agent are biodegradable. Therefore, the resin composition is environmentally friendly.

The nucleating agent of the present invention does not include a free carboxy group that may cause hydrolysis during processing of a polyester resin but includes a metal carboxylate group. Therefore, the nucleating agent can solve the problem of hydrolysis, and in addition, has improved performance as the nucleating agent.

According to the present invention, by reacting an amino acid with a metal salt, a metal oxide, or a metal hydroxide (hereinafter, also called a metal compound) in an amount more than an equivalent amount of carboxy group of the amino acid, in particular, by the reaction in a solvent in which the metal compound is poorly soluble to produce an amino acid metal salt, it is possible to obtain an amino acid metal salt having particularly excellent activity as the nucleating agent.

In particular, by the production method of the present invention, the obtained amino acid metal salt has the activity as the nucleating agent that is the same as or higher than that of an amino acid metal salt obtained by a related-art production method in which an amino acid is reacted with a metal compound in an amount substantially equivalent molar amount of carboxy group of the amino acid used.

In addition, when the amino acid metal salt produced by the production method of the present invention is used as the nucleating agent during the production of a crystalline resin including a polyester resin such as a poly(lactic acid) resin and a crystalline polyolefin resin, it is expected that the amino acid metal salt further improves the crystallization promotion effect on such a resin. Consequently, it is possible to provide a crystalline resin composition having excellent heat resistance and moldability.

### MODES FOR CARRYING OUT THE INVENTION

A crystalline resin composition of the present invention is characterized by including a crystalline resin and an amino acid metal salt as a nucleating agent. A nucleating agent including the amino acid metal salt is also a subject of the present invention.

In addition, a method for producing the amino acid metal salt is also a subject of the present invention.

The present invention will now be described in further detail.

<Amino Acid Metal Salt: Nucleating Agent>

For an amino acid for an amino acid metal salt in the present invention, known amino acids may be used. Amino acids include various enantiomers, and are also classified based on the binding positions of a carboxy group and an amino group. Simply called amino acids generally mean L-α-amino acids, but in the present invention, amino acids to be used may be in a D-form, an L-form, and a DL-form (racemic form), and various amino acids except α-amino acids, such as β-amino acids, γ-amino acids, and δ-amino acids may be used.

Examples of the typical amino acid include alanine, asparagine, aspartic acid, arginine, isoleucine, glycine, glutamine, glutamic acid, cysteine, threonine, serine, tyrosine, tryptophan, valine, histidine, phenylalanine, proline, methionine, lysine, and leucine. In addition to these amino acids, an amino acid including a basic skeleton having an amino group and a carboxy group as the basic structure of amino acid into which various elements or functional groups are introduced may also be used.

Among them, an amino acid into which an aromatic group is introduced is preferred. The aromatic group may be a heterocyclic group, and various substituents may be introduced into the aromatic group. Specific examples of such an amino acid include tryptophan and phenylalanine.

As the metal species in an amino acid metal salt used in the present invention, monovalent, divalent, and trivalent metals may be used. These metal salts may be used as a mixture of two or more of metals. Specific examples of the metal include lithium, sodium, potassium, magnesium, calcium, barium, aluminum, manganese, iron, cobalt, copper, nickel, zinc, silver, and tin. Among them, cobalt, copper, and zinc are preferred and zinc is more preferred.

<Amino Acid Metal Salt: Production Method>

The amino acid metal salt used in the present invention can be typically obtained as a crystalline powder by a production method in which an amino acid and a metal compound are mixed and reacted in an appropriate solvent (medium), then the used solvent is removed by filtration or distillation, and the residue is dried.

Particularly preferably, the amino acid metal salt is produced by reacting an amino acid (a) with a metal compound (a metal salt, a metal oxide, or a metal hydroxide) (b) in an amount more than an equivalent amount of the amino acid, in particular, by the reaction in a solvent in which the metal compound (b) is poorly soluble. The production method is a subject of the present invention.

Examples of the metal compound include an oxide of the metal species, a hydroxide of the metal species, and, as a metal salt of the metal species, a chloride, a carbonate, a sulfate, a nitrate, and an organic salt of the metal species. Commercial products may be used when such a compound is commercially available.

As specific examples of a combination with the metal species, the metal compound is preferably zinc oxide, zinc chloride, cobalt chloride, or copper chloride, and particularly preferably zinc oxide.

The solvent (medium) used in the mixing reaction is not particularly limited. However, a preferable solvent is a solvent in which an amino acid as a raw material is soluble from the viewpoint of reaction efficiency, and in which a metal compound and an amino acid metal salt as raw materials are poorly soluble from the viewpoint of collection of a final product.

Examples of such a solvent include water; ketones such as acetone, methyl ethyl ketone, and methyl isobutyl ketone; nitriles such as acetonitrile; ethers such as tetrahydrofuran; alcohols such as methanol, ethanol, 1-propanol, and 2-propanol; amides such as N,N-dimethylformamide, N,N-dimethylacetamide, and N-methyl-2-pyrrolidone; and sulfoxides such as dimethyl sulfoxide. These solvents may be used alone or as a mixture of two or more of them. Among them, water and alcohols are preferred and, considering ease of handling and economic efficiency, water is more preferably used.

In the reaction, the total charged amount of the solvent is preferably 0.001 to 1,000 times with respect to the total charged mass of the amino acid (a) and the metal compound (b). The lower limit of the total charged amount of the solvent is more preferably 0.002 times, and particularly preferably 0.01 times with respect to the total charged mass of the amino acid (a) and the metal compound (b). The upper limit of the total charged amount of the solvent is more preferably 200 times, particularly preferably 100 times, and even more preferably 50 times, with respect to the total charged mass of the amino acid (a) and the metal compound (b).

The amino acid (a) and the metal compound (b) can be mixed without using a solvent (medium). However, in such a case, the reaction progresses too slowly, thereby leading to industrial disadvantage. Meanwhile, the use of a solvent in an excess amount lowers volumetric efficiency, thereby also leading to industrial disadvantage.

As for the charged molar ratio of an amino acid and a metal compound, the amino acid metal salt can be typically obtained by using about 1 to 2 molar equivalents of a metal compound (for example, about 0.5 to 1 mol of a divalent metal compound) with respect to 1 mol of carboxy group of an amino acid. When an amino acid is used in an excess molar ratio, the amount of the amino acid metal salt produced is not increased but a surplus amino acid may invite the hydrolysis of a polyester resin, and this may cause coloration or reduction in physical properties of a molded product.

In the present invention, the amino acid and the metal compound are preferably used in a molar equivalent ratio (=molar equivalent amount of the metal compound (b): molar equivalent amount of carboxy group of the amino acid (a)) of 100:0.01 to 100:90 as the charged amounts, in other words, the metal compound is preferably used in an excess molar amount of the molar equivalent amount of carboxy group of the amino acid. Particularly preferably, as the upper limit of the charged amount of the amino acid (a), the molar equivalent ratio of the metal compound (b): the amino acid (a) is 100:80 and even more preferably (b): (a) is 100:70. As the lower limit of the charged amount of the amino acid (a), the molar equivalent ratio of the metal compound (b): amino acid (a) is more preferably 100:0.1, particularly preferably (b): (a) is 100:1, and most preferably (b): (a) is 100:2.

As an actual procedure of the mixing reaction, for example, an amino acid and a metal compound as the raw materials are added to the solvent described above and the mixture is stirred. Specifically, the mixing reaction is carried out by, for example, a method of adding a solution of the amino acid to a slurry containing the metal compound as the raw material, a method of adding a solution of the amino acid into the metal compound, and a method of adding a solvent into a mixture of the metal compound and the amino acid. Here, examples of the solvent used for the slurry, the solution of the amino acid, and the solvent to be added include the solvents exemplified above. When an acidic compound such as a chloride, a sulfate, and a nitrate is used as the metal compound, a basic compound is preferably added to the acidic compound to make the system neutral to alkaline.

The reaction apparatus is not particularly limited as long as a reaction system can be thoroughly moved. Examples of the reaction apparatus include a reaction vessel equipped with stirring blades, and various mixers such as a homomixer, a Henschel mixer, and a Loedige mixer and various pulverizers such as a ball mill, a bead mill, and an ultimizer. Among them, when a mixer that has excellent mixing performance of powder and can perform mixing, heating, and the like at the same time or in sequence, e.g., a Henschel mixer or a Loedige mixer is used, the amount of a medium used in the reaction can be significantly reduced, thereby improving volumetric efficiency. In addition, such an apparatus enables the reaction and drying described later in the same apparatus, thereby leading to industrial advantage.

When a metal compound is used in an excess amount to prepare an amino acid metal salt, in order to obtain a powder in which the produced amino acid metal salt is uniformly dispersed in the surplus metal compound as the raw material (see details described later), the solution or the solvent is preferably added dropwise or at once while stirring the slurry, the metal compound, or the mixture with stirring blades or the like.

The reaction temperature of the mixing reaction varies depending on an amino acid and a metal compound to be used but is typically appropriately selected within a range from 0° C. to the boiling point of a medium used. The lower limit of the reaction temperature is more preferably 40° C. or 50° C. and the upper limit temperature of the reaction temperature is more preferably 80° C. or 70° C. The reaction time varies depending on raw materials to be used, a medium to be used, and a reaction temperature, and is typically 0.5 to 24 hours.

After the completion of the reaction, a medium is removed by filtration or distillation and the residue is dried. Here, when a metal compound is used in an excess amount to produce the amino acid metal salt, a product can be obtained in a so-called “complex” form including the amino acid metal salt and the surplus metal salt, the surplus metal oxide, or the surplus metal hydroxide assembled around the amino acid metal salt. Here, the “complex” may have a form in which particles of the amino acid metal salt are dispersed in a particle group of the metal compound as the raw material, that is, a crystalline powder form of the metal salt, the metal oxide, or the metal hydroxide in which the amino acid metal salt is dispersed and may also include a composite in which the amino acid metal salt adheres onto the entire or partial surface of the metal compound particles.

The drying temperature at this time may be appropriately selected depending on the type of a medium and the drying may be performed under reduced pressure.

When water is used as the medium, the drying temperature is preferably 100 to 500° C., and more preferably 100 to 200° C. at atmospheric pressure.

The amino acid metal salt used in the present invention preferably has an average particle diameter of 50 μm or less. The average particle diameter is more preferably 10 μm or less. Here, the average particle diameter (μm) is a 50% volume diameter (median diameter) obtained from measurement by a laser diffraction-scattering method based on the Mie theory. A smaller average particle diameter is preferred because the crystallization speed is likely to increase.

The amino acid metal salt obtained by the common method and the amino acid metal salt obtained using the metal compound in an excess amount may be further pulverized in order to reduce the particle diameter, as necessary, by a mixer providing shear force, such as a homomixer, a Henschel mixer, and a Loedige mixer or a pulverizer such as a ball mill, a pinned disk mill, a pulverizer, an Inomizer, and a counter jet mill.

<Crystalline Resin>

The crystalline resin in the present invention is a resin in which a so-called melting point is observed. Examples of the crystalline resin include a polyolefin resin such as polyethylene (PE), a polyethylene copolymer, polypropylene (PP), a polypropylene copolymer, polybutylene, ultra high-molar mass polyethylene (UHPE), poly(4-methyl-1-pentene), and polytetrafluoroethylene (PTFE); a polyester resin such as poly(lactic acid), a copolymer of 3-hydroxybutyric acid and 3-hydroxyhexanoic acid (PHBH: poly(3-hydroxybutyrate-co-3-hydroxyhexanoate)), poly(ethylene terephthalate) (PET), and poly(butylene terephthalate) (PBT); a polyamide resin (PA); a polyacetal resin (POM); a poly(phenylene sulfide) resin (PPS); and a polyetheretherketone (PEEK). Among them, a polyolefin resin and a polyester resin are preferred, and a polypropylene resin and a poly(lactic acid) resin are more preferred.

The poly(lactic acid) resin includes a homopolymer or a copolymer of lactic acid. When the poly(lactic acid) resin is a copolymer, the sequence pattern of the copolymer may be any of a random copolymer, an alternating copolymer, a block copolymer, and a graft copolymer. The poly(lactic acid) resin may be a blend polymer with an additional resin including a homopolymer or a copolymer of lactic acid as a main component. Examples of the additional resin include a biodegradable resin except the poly(lactic acid) resin described later, a general-purpose thermoplastic resin, and a general-purpose thermoplastic engineering plastic.

Examples of the poly(lactic acid) resin include, but are not necessarily limited to, a resin obtained by ring-opening polymerization of lactide, and a resin obtained by direct polycondensation of D-lactic acid, L-lactic acid, racemic lactic acid, or the like. The poly(lactic acid) resin typically has a number average molecular weight of about 10,000 to 500,000. In addition, a cross-linked product of a poly(lactic acid) resin with a crosslinking agent by using, for example, heat, light, or radiation beams can be used.

Examples of the biodegradable resin except the poly(lactic acid) resin include poly(hydroxyalkanoic acid)s such as poly(3-hydroxybutyric acid) and a copolymer of 3-hydroxybutyric acid and 3-hydroxyhexanoic acid (PHBH); polycaprolactone; glycol esters such as poly(butylene succinate), poly(butylene succinate/adipate), poly(butylene succinate/carbonate), poly(ethylene succinate), and poly(ethylene succinate/adipate); poly(vinyl alcohol); poly(glycolic acid); modified starch; cellulose acetate; chitin and chitosan; and lignin.

Examples of the general-purpose thermoplastic resin include a polyolefin resin such as polyethylene (PE), a polyethylene copolymer, polypropylene (PP), a polypropylene copolymer, polybutylene (PB), an ethylene-vinyl acetate copolymer (EVA), an ethylene-ethyl acrylate copolymer (EEA), and poly(4-methyl-1-pentene); a polystyrene resin such as polystyrene (PS), high-impact polystyrene (HIPS), an acrylonitrile-styrene copolymer (AS), and an acrylonitrile-butadiene-styrene copolymer (ABS); a vinyl chloride resin; a polyurethane resin; a phenolic resin; an epoxy resin; an amino resin; and an unsaturated polyester resin.

Examples of the general-purpose engineering plastic include a polyamide resin, a polycarbonate resin, a polyphenylene ether resin, a modified polyphenylene ether resin, a polyester resin such as poly(ethylene terephthalate) (PET) and poly(butylene terephthalate) (PBT), a polyacetal resin, a polysulfone resin, a poly(phenylene sulfide) resin, and a polyimide resin.

<Crystalline Resin Composition>

In the crystalline resin composition of the present invention, the amount of the amino acid metal salt (nucleating agent) is preferably 0.01 to 10.0 parts by mass based on 100 parts by mass of the crystalline resin. The amino acid metal salt used here includes both an amino acid metal salt obtained by a related-art reaction of an amino acid with a metal compound in a molar amount substantially equivalent amount of carboxy group of the amino acid, and an amino acid metal salt obtained by the production method of the present invention in which a metal salt compound is used in an excess amount (in a complex form of an amino acid metal salt including the amino acid metal salt and a surplus metal salt, a surplus metal oxide, or a surplus metal hydroxide).

The amount is more preferably 0.02 to 5.0 parts by mass, and even more preferably 0.03 to 2.0 parts by mass. A crystalline resin composition containing the amino acid metal salt in an amount of less than 0.01 part by mass makes it difficult to sufficiently increase the crystallization speed of a crystalline resin. A crystalline resin composition containing the amino acid metal salt in an amount of more than 10 parts by mass achieves a high crystallization speed of a crystalline resin but the crystallization speed is not further increased.

In the present invention, the method of adding an amino acid metal salt to a crystalline resin is not particularly limited, and the addition is performed by a known method. For example, a crystalline resin and each component may be mixed with any mixer and be kneaded with, for example, a single screw extruder or a twin screw extruder. The kneading is typically performed at a temperature of about 150 to 220° C. As an alternative method, a masterbatch containing an amino acid metal salt at a high concentration may be prepared and the masterbatch may be added to a crystalline resin. Alternatively, an amino acid metal salt may be added at a polymerization step of a crystalline resin.

In order to further improve the crystallization promotion effect, the crystalline resin composition of the present invention may include, in addition to the amino acid metal salt, a known nucleating agent in combination. Specific examples of the additional nucleating agent include inorganic particles such as talc particles and boron nitride particles; amides such as ethylenebis(stearylamide), ethylene bis(12-hydroxystearic acid amide), and trimesic acid tricyclohexyl triamide; sorbitols such as dibenzylidene sorbitol; metal phosphates such as aluminum bis(2,2′-methylenebis(4,6-di-tert-butylphenyl)phosphate)hydroxide; basic inorganic aluminum compounds such as aluminum hydroxide; and metal phosphonates such as zinc phenylphosphonate and calcium phenylphosphonate.

The crystalline resin composition of the present invention may include a known inorganic filler. Examples of the inorganic filler include glass fiber, carbon fiber, talc, mica, silica, kaolin, clay, wollastonite, glass beads, glass flakes, potassium titanate, calcium carbonate, magnesium sulfate, and titanium oxide. Such an inorganic filler may be in any form of a fibrous form, a granular form, a plate form, an acicular form, a spherical form, and a powder form. Such an inorganic filler may be used in an amount of 300 parts by mass or less based on 100 parts by mass of the crystalline resin. A known organic fiber such as cellulose may also be used as an organic filler.

The crystalline resin composition of the present invention may include a known fire retardant. Examples of the fire retardant include a halogen-containing fire retardant such as a bromine-containing fire retardant and a chlorine-containing fire retardant; an antimony-containing fire retardant such as antimony trioxide and antimony pentoxide; an inorganic fire retardant such as aluminum hydroxide, magnesium hydroxide, and a silicone compound; a phosphorus-containing fire retardant such as red phosphorus, phosphoric acid esters, ammonium polyphosphate, and phosphazene; a melamine fire retardant such as melamine, melam, melem, melon, melamine cyanurate, melamine phosphate, melamine pyrophosphate, melamine polyphosphate, a melamine melam melem polyphosphate double salt, melamine alkylphosphonate, melamine phenylphosphonate, melamine sulfate, and melam methanesulfonate; and a fluorine resin such as PTFE. Such a fire retardant may be used in an amount of 200 parts by mass or less based on 100 parts by mass of the crystalline resin.

When the crystalline resin is a resin susceptible to hydrolysis, such as a poly(lactic acid) resin, a known hydrolysis inhibitor may be used. Examples of the hydrolysis inhibitor include a carbodiimide compound, an isocyanate compound, and an oxazoline compound. These compounds may be used alone or in combination of two or more of them. The amount of the hydrolysis inhibitor may be 10 parts by mass or less, and is preferably 5 parts by mass or less, and even more preferably 1 part by mass or less, based on 100 parts by mass of the crystalline resin.

In addition to the components described above, the crystalline resin composition may include various additives that are generally used in the production of a common synthetic resin, including a heat stabilizer, a light stabilizer, an ultraviolet absorber, an antioxidant, an impact modifier, an antistatic agent, a pigment, a colorant, a mold release agent, a lubricant, a plasticizer, a compatibilizer, a foaming agent, a perfume, antibacterial and antifungal agents, various coupling agents such as a silane coupling agent, a titanium coupling agent, and an aluminum coupling agent, various additional fillers, and an additional nucleating agent, in combination.

The crystalline resin composition of the present invention can be molded by common molding such as injection molding, blow molding, vacuum molding, and compression molding, thereby easily providing various molded products.

### EXAMPLES

The present invention will be described more specifically below with reference to examples, but the present invention is not limited to the description.

In the examples, apparatuses and conditions used for the preparation and the analysis of physical properties of samples are as below.

### (1) Melting and Kneading

Apparatus: Labo Plastomill Micro KF6V manufactured by Toyo Seiki Seisaku-sho, Ltd.

### (2) Differential Scanning Calorimetry (DSC)

Apparatus: Diamond DSC manufactured by PerkinElmer Co., Ltd.

Abbreviations are as follows.
L-Phe: L-phenylalanine [manufactured by Kanto Chemical Co., Inc.]
L-Trp: L-tryptophan [manufactured by Kanto Chemical Co., Inc.]
D-Trp: D-tryptophan [manufactured by Kanto Chemical Co., Inc.]
PLA: poly(lactic acid) resin [manufactured by NatureWorks LLC, Ingeo 3001D]
PHBH: poly(3-hydroxybutyrate-co-3-hydroxyhexanoate) resin [manufactured by Kaneka Corporation]
PP: polypropylene resin [manufactured by Japan Polypropylene Corporation, Novatec (registered trademark) PP MA3]
EBS: ethylene bis(12-hydroxystearic acid amide) [manufactured by Nippon Kasei Chemical Co., Ltd., Slipacks (registered trademark) H]

### Synthesis Example 1

### Preparation of L-Phe-Zn

Into a 100-mL glass container equipped with a stirrer, 8.26 g (50 mmol) of L-Phe and 50 g of water were charged and the whole was stirred. To the mixture, 2.03 g (25 mmol) of zinc oxide [manufactured by HakusuiTech Co., Ltd., JIS 2] was further added and the whole was reacted at 60° C. for 1 hour. Then, the reaction mixture was cooled to room temperature (about 25° C.) and the precipitated solid was collected by filtration. The washing process in which the obtained solid was dispersed in 100 mL of water and was collected by filtration was repeated twice. The obtained wet product was dried at 110° C. for 6 hours, thereby obtaining 6.81 g of an intended L-phenylalanine zinc (L-Phe-Zn) powder.

### Synthesis Example 2

### Preparation of L-Trp-Zn

Into a 100-mL glass container equipped with a stirrer, 2.04 g (10 mmol) of L-Trp and 50 g of water were charged and the whole was stirred. To the mixture, 0.45 g (5.5 mmol) of zinc oxide [manufactured by HakusuiTech Co., Ltd., JIS 2] was further added and the whole was reacted at 60° C. for 3 hours. Then, the reaction mixture was cooled to room temperature (about 25° C.) and the precipitated solid was collected by filtration. The washing process in which the obtained solid was dispersed in 100 mL of water and was collected by filtration was repeated twice. The obtained wet product was dried at 110° C. for 6 hours, thereby obtaining 2.23 g of an intended L-tryptophan zinc (L-Trp-Zn) powder.

### Synthesis Example 3

### Preparation of L-Trp-Zn

Into a 100-mL glass container equipped with a stirrer, 2.04 g (10 mmol) of L-Trp and 50 g of water were charged and the whole was stirred. To the mixture, 0.40 g (10 mmol) of sodium hydroxide was further added to prepare a homogeneous solution. To the solution, an aqueous solution dissolving 0.68 g (5 mmol) of zinc chloride [manufactured by Wako Pure Chemical Industries, Ltd.] in 10 g of water was added and the whole was reacted at room temperature (about 25° C.) for 1 hour. After the reaction, the precipitated solid was collected by filtration, and the washing process in which the obtained solid was dispersed in 100 mL of water and was collected by filtration was repeated twice. The obtained wet product was dried at 110° C. for 6 hours, thereby obtaining 1.82 g of an intended L-tryptophan zinc (L-Trp-Zn) powder.

### Synthesis Example 4

### Preparation of D-Trp-Zn

Into a 100-mL glass container equipped with a stirrer, 2.04 g (10 mmol) of D-Trp and 50 g of water were charged and the whole was stirred. To the mixture, 0.45 g (5.5 mmol) of zinc oxide [manufactured by HakusuiTech Co., Ltd., JIS 2] was further added and the whole was reacted at 60° C. for 3 hours. Then, the reaction mixture was cooled to room temperature (about 25° C.) and the precipitated solid was collected by filtration. The washing process in which the obtained solid was dispersed in 100 mL of water and was collected by filtration was repeated twice. The obtained wet product was dried at 110° C. for 6 hours, thereby obtaining 2.01 g of an intended D-tryptophan zinc (D-Trp-Zn) powder.

### Synthesis Example 5

### Preparation of L-Trp-Co

Into a 100-mL glass container equipped with a stirrer, 2.04 g (10 mmol) of L-Trp and 50 g of water were charged and the whole was stirred. To the mixture, 0.40 g (10 mmol) of sodium hydroxide was further added to prepare a homogeneous solution. To the solution, an aqueous solution dissolving 1.20 g (5 mmol) of cobalt chloride hexahydrate [manufactured by Wako Pure Chemical Industries, Ltd.] in 10 g of water was added and the whole was reacted at room temperature (about 25° C.) for 1 hour. After the reaction, the precipitated solid was collected by filtration, and the washing process in which the obtained solid was dispersed in 100 mL of water and was collected by filtration was repeated twice. The obtained wet product was dried at 110° C. for 6 hours, thereby obtaining 1.54 g of an intended L-tryptophan cobalt (L-Trp-Co) powder.

### Synthesis Example 6

### Preparation of L-Trp-Cu

Into a 100-mL glass container equipped with a stirrer, 2.04 g (10 mmol) of L-Trp and 50 g of water were charged and the whole was stirred. To the mixture, 0.40 g (10 mmol) of sodium hydroxide was further added to prepare a homogeneous solution. To the solution, an aqueous solution dissolving 0.67 g (5 mmol) of copper chloride [manufactured by Wako Pure Chemical Industries, Ltd.] in 10 g of water was added and the whole was reacted at room temperature (about 25° C.) for 1 hour. After the reaction, the precipitated solid was collected by filtration, and the washing process in which the obtained solid was dispersed in 100 mL of water and was collected by filtration was repeated twice. The obtained wet product was dried at 110° C. for 6 hours, thereby obtaining 2.15 g of an intended L-tryptophan copper (L-Trp-Cu) powder.

### Example 1

To 100 parts by mass of PLA, 1 part by mass of L-Phe-Zn obtained in Synthesis Example 1 was added as a nucleating agent and the whole was melted and kneaded at 185° C. for 5 minutes. From the obtained PLA resin composition, about 5 mg of a sample was taken out and the crystallization behavior was evaluated with a DSC. For the evaluation, in a DSC apparatus, the sample in a molten state at 200° C. was cooled at 10° C./min. The evaluation was carried out using the temperature (Tc) at an observed exothermic peak due to crystallization and using the calorific value (ΔB) obtained from a peak area. A higher Tc value shows a higher crystallization speed and the ΔH value is an index of final crystallinity. The results are shown in Table 1.

### Example 2

The evaluation was carried out in the same manner as in Example 1 except that L-Trp-Zn obtained in Synthesis Example 3 was used as the nucleating agent. The results are also shown in Table 1.

### Example 3

The evaluation was carried out in the same manner as in Example 1 except that D-Trp-Zn obtained in Synthesis Example 4 was used as the nucleating agent. The results are also shown in Table 1.

### Example 4

The evaluation was carried out in the same manner as in Example 1 except that L-Trp-Co obtained in Synthesis Example 5 was used as the nucleating agent. The results are also shown in Table 1.

### Example 5

The evaluation was carried out in the same manner as in Example 1 except that L-Trp-Cu obtained in Synthesis Example 6 was used as the nucleating agent. The results are also shown in Table 1.

### Example 30

The evaluation was carried out in the same manner as in Example 1 except that a mixed powder of 1 part by mass of L-Trp-Zn obtained in Synthesis Example 2 and 0.5 part by mass of EBS was used as the nucleating agent. The results are also shown in Table 1.

### Example 31

The evaluation was carried out in the same manner as in Example 1 except that a mixed powder of 0.5 part by mass of L-Trp-Zn obtained in Synthesis Example 2 and 0.5 part by mass of EBS was used as the nucleating agent. The results are also shown in Table 1.

### Comparative Example 1

The evaluation was carried out in the same manner as in Example 1 except that L-Trp was used as the nucleating agent. The results are also shown in Table 1.

### Comparative Example 2

The evaluation was carried out in the same manner as in Example 1 except that no nucleating agent was added. The results are also shown in Table 1.

### Comparative Example 5

The evaluation was carried out in the same manner as in Example 1 except that 0.5 part by mass of EBS was used as the nucleating agent. The results are also shown in Table 1.

TABLE 1

| | | Amount of | | |
|---|---|---|---|---|
| | Nucleating | nucleating agent | Tc | ΔH |
| | agent | [part by mass] | [° C.] | [J/g] |
| Example 1 | L-Phe-Zn | 1 | 111.5 | 37.5 |
| Example 2 | L-Trp-Zn | 1 | 129.6 | 46.1 |
| Example 3 | D-Trp-Zn | 1 | 119.9 | 41.3 |
| Example 4 | L-Trp-Co | 1 | 119.9 | 42.8 |
| Example 5 | L-Trp-Cu | 1 | 110.9 | 36.2 |
| Example 30 | L-Trp-Zn | 1 | 130.1 | 36.7 |
| | EBS | 0.5 | | |
| Example 31 | L-Trp-Zn | 0.5 | 129.2 | 40.1 |
| | EBS | 0.5 | | |
| Comparative Example 1 | L-Trp | 1 | 105.2 | 14.8 |
| Comparative Example 2 | — | — | 106.8 | 30.7 |
| Comparative Example 5 | EBS | 0.5 | 106.9 | 28.1 |

From the results in Table 1, it was shown that each composition including the amino acid metal salt as the nucleating agent (Examples 1 to 5) exhibited a higher Tc and a higher ΔH than those of the composition including an amino acid as the nucleating agent (Comparative Example 1), the composition with no nucleating agent (Comparative Example 2), and the composition including EBS as a known nucleating agent (Comparative Example 5), and had crystallization promotion effect. It was ascertained that the composition including both an amino acid metal salt and EBS as the nucleating agent (Examples 30 and 31) also had high crystallization promotion effect.

### Example 6

### Preparation of L-Trp-Zn-M0.7

Into a 100-mL glass container equipped with a stirrer, 1.43 g (7 mmol) of L-Trp and 50 g of water were charged and the whole was stirred. To the mixture, 0.41 g (5 mmol) of zinc oxide [manufactured by HakusuiTech Co., Ltd., JIS 2] was further added and the whole was reacted at 60° C. for 3 hours. Then, the reaction mixture was cooled to room temperature (about 25° C.) and the precipitated solid was collected by filtration. The washing process in which the obtained solid was dispersed in 100 mL of water and was collected by filtration was repeated twice. The obtained wet product was dried at 110° C. for 6 hours, thereby obtaining 1.70 g of an intended zinc oxide-containing L-tryptophan zinc powder (L-Trp-Zn-M0.7).

### Example 7

### Preparation of L-Trp-Zn-M0.5

In the same manner as in Example 6 except that the amount of L-Trp used was 1.02 g (5 mmol), 1.31 g of an intended zinc oxide-containing L-tryptophan zinc powder (L-Trp-Zn-M0.5) was obtained.

### Example 8

### Preparation of L-Trp-Zn-M0.3

In the same manner as in Example 6 except that the amount of L-Trp used was 0.61 g (3 mmol), 0.94 g of an intended zinc oxide-containing L-tryptophan zinc powder (L-Trp-Zn-M0.3) was obtained.

### Example 9

### Preparation of L-Trp-Zn-M0.2

In the same manner as in Example 6 except that the amount of L-Trp used was 0.41 g (2 mmol), 0.74 g of an intended zinc oxide-containing L-tryptophan zinc powder (L-Trp-Zn-M0.2) was obtained.

### Example 10

### Preparation of L-Trp-Zn-M0.1

In the same manner as in Example 6 except that the amount of L-Trp used was 0.20 g (1 mmol), 0.57 g of an intended zinc oxide-containing L-tryptophan zinc powder (L-Trp-Zn-M0.1) was obtained.

### Example 11

### Preparation of L-Trp-Zn-M0.07

In the same manner as in Example 6 except that the amount of L-Trp used was 0.14 g (0.7 mmol), 0.47 g of an intended zinc oxide-containing L-tryptophan zinc powder (L-Trp-Zn-M0.07) was obtained.

### Example 12

### Preparation of L-Trp-Zn-M0.05

In the same manner as in Example 6 except that the amount of L-Trp used was 0.10 g (0.5 mmol), 0.45 g of an intended zinc oxide-containing L-tryptophan zinc powder (L-Trp-Zn-M0.05) was obtained.

### Example 13

### Preparation of L-Trp-Zn-M0.03

In the same manner as in Example 6 except that the amount of L-Trp used was 0.06 g (0.3 mmol), 0.43 g of an intended zinc oxide-containing L-tryptophan zinc powder (L-Trp-Zn-M0.03) was obtained.

### Example 14

### Preparation of L-Trp-Zn-M0.01

In the same manner as in Example 6 except that the amount of L-Trp used was 0.02 g (0.1 mmol), 0.39 g of an intended zinc oxide-containing L-tryptophan zinc powder (L-Trp-Zn-M0.01) was obtained.

### Example 15

The evaluation was carried out in the same manner as in Example 1 except that L-Trp-Zn-M0.7 obtained in Example 6 was used as the nucleating agent. The results are shown in Table 2.

### Example 16

The evaluation was carried out in the same manner as in Example 1 except that L-Trp-Zn-M0.5 obtained in Example 7 was used as the nucleating agent. The results are also shown in Table 2.

### Example 17

The evaluation was carried out in the same manner as in Example 1 except that L-Trp-Zn-M0.3 obtained in Example 8 was used as the nucleating agent. The results are also shown in Table 2.

### Example 18

The evaluation was carried out in the same manner as in Example 1 except that L-Trp-Zn-M0.2 obtained in Example 9 was used as the nucleating agent. The results are also shown in Table 2.

### Example 19

The evaluation was carried out in the same manner as in Example 1 except that L-Trp-Zn-M0.1 obtained in Example 10 was used as the nucleating agent. The results are also shown in Table 2.

### Example 20

The evaluation was carried out in the same manner as in Example 1 except that L-Trp-Zn-M0.07 obtained in Example 11 was used as the nucleating agent. The results are also shown in Table 2.

### Example 21

The evaluation was carried out in the same manner as in Example 1 except that L-Trp-Zn-M0.05 obtained in Example 12 was used as the nucleating agent. The results are also shown in Table 2.

### Example 22

The evaluation was carried out in the same manner as in Example 1 except that L-Trp-Zn-M0.03 obtained in Example 13 was used as the nucleating agent. The results are also shown in Table 2.

### Example 23

The evaluation was carried out in the same manner as in Example 1 except that L-Trp-Zn-M0.01 obtained in Example 14 was used as the nucleating agent. The results are also shown in Table 2.

### Example 24

The evaluation was carried out in the same manner as in Example 1 except that a mixed powder of 0.93 part by mass of L-Trp-Zn obtained in Synthesis Example 2 and 0.07 part by mass of zinc oxide [manufactured by HakusuiTech Co., Ltd., JIS 2] was used as the nucleating agent. The results are also shown in Table 2.

### Example 25

The evaluation was carried out in the same manner as in Example 1 except that a mixed powder of 0.85 part by mass of L-Trp-Zn obtained in Synthesis Example 2 and 0.15 part by mass of zinc oxide [manufactured by HakusuiTech Co., Ltd., JIS 2] was used as the nucleating agent. The results are also shown in Table 2.

### Example 26

The evaluation was carried out in the same manner as in Example 1 except that a mixed powder of 0.71 part by mass of L-Trp-Zn obtained in Synthesis Example 2 and 0.29 part by mass of zinc oxide [manufactured by HakusuiTech Co., Ltd., JIS 2] was used as the nucleating agent. The results are also shown in Table 2.

### Example 27

The evaluation was carried out in the same manner as in Example 1 except that a mixed powder of 0.39 part by mass of L-Trp-Zn obtained in Synthesis Example 2 and 0.61 part by mass of zinc oxide [manufactured by HakusuiTech Co., Ltd., HIS 2] was used as the nucleating agent. The results are also shown in Table 2.

TABLE 2

| | | | | Amount of | | |
|---|---|---|---|---|---|---|
| | | Amount | | L-Trp-Zn | | |
| | | of | | in | | |
| | | nucleating | | nucleating | | |
| | | agent | L-Trp-Zn/ZnO | agent | | |
| | Nucleating | [part by | molar | added [part | Tc | ΔH |
| | agent | mass] | equivalent ratio | by mass] | [° C.] | [J/g] |
| Example 2 | L-Trp-Zn | 1 | 100/0 | 1.00 | 129.6 | 46.1 |
| (shown | | | | | | |
| again) | | | | | | |
| Example 15 | L-Trp-Zn-M0.7 | 1 | 70/30 | 0.93 | 132.8 | 40.7 |
| Example 16 | L-Trp-Zn-M0.5 | 1 | 50/50 | 0.85 | 132.9 | 40.6 |
| Example 17 | L-Trp,Zn-M0.3 | 1 | 30/70 | 0.71 | 131.5 | 42.0 |
| Example 18 | L-Trp-Zn-M0.2 | 1 | 20/80 | 0.59 | 131.7 | 41.5 |
| Example 19 | L-Trp-Zn-M0.1 | 1 | 10/90 | 0.39 | 131.7 | 42.2 |
| Example 20 | L-Trp-Zn-M0.07 | 1 | 7/93 | 0.30 | 127.4 | 40.8 |
| Example 21 | L-Trp-Zn-M0.05 | 1 | 5/95 | 0.23 | 127.1 | 39.0 |
| Example 22 | L-TrprZn-M0.03 | 1 | 3/97 | 0.15 | 125.4 | 39.2 |
| Example 23 | L-Trp-Zn-M0.01 | 1 | 1/99 | 0.06 | 117.5 | 40.1 |
| Example 24 | L-Trp-Zn | 0.93 | 70/30 | 0.93 | 129.8 | 40.9 |
| | Zinc oxide | 0.07 | | | | |
| Example 25 | L-Trp-Zn | 0.85 | 50/50 | 0.85 | 128.3 | 37.9 |
| | Zinc oxide | 0.15 | | | | |
| Example 26 | L-Trp-Zn | 0.71 | 30/70 | 0.71 | 129.3 | 41.1 |
| | Zinc oxide | 0.29 | | | | |
| Example 27 | L-Trp-Zn | 0.39 | 10/90 | 0.39 | 128.8 | 40.0 |
| | Zinc oxide | 0.61 | | | | |
| Comparative | — | — | — | — | 106.8 | 30.7 |
| Example 2 | | | | | | |
| (shown | | | | | | |
| again) | | | | | | |

As shown in Table 2, each PLA resin composition (Example 15 to Example 23) including, as the nucleating agent, L-tryptophan zinc containing zinc oxide obtained in Example 6 to Example 14 in which the metal oxide (zinc oxide) was used in an excess amount of the equivalent amount of carboxy group of the amino acid (L-tryptophan) exhibited a higher Tc and a higher ΔH than those of the composition with no nucleating agent (Comparative Example 2) and had crystallization promotion effect.

In particular, each composition in Example 15 to Example 19 exhibited a higher Tc than that of the PLA resin composition in Example 2 including, as the nucleating agent, L-tryptophan zinc produced in Synthesis Example 3 in which the metal oxide and the amino acid were used in an equivalent molar amount.

From the results, each PLA resin composition of Example 24 to Example 27 including a mixture of zinc oxide and L-tryptophan zinc produced in Synthesis Example 2 in which the metal oxide and the amino acid were used in a substantially equivalent molar amount also exhibited a higher Te and a higher ΔH than those of the composition with no nucleating agent (Comparative Example 2) and exhibited substantially the same Tc as that of the PLA resin composition of Example 2 including L-tryptophan zinc of Synthesis Example 3 as the nucleating agent.

Comparing each composition of Example 15 to Example 19 including L-tryptophan zinc that was produced by using the metal oxide (zinc oxide) in an excess amount with each composition of Example 24 to Example 27 including a mixture of L-tryptophan zinc and zinc oxide, the results revealed that the former L-tryptophan zinc (the metal oxide containing L-tryptophan zinc obtained by the production method of the present invention) exhibited a higher Te and a higher ΔH. The reason for the result is unclear but one of the reasons is supposed to be that, comparing with the system mixing L-tryptophan zinc and zinc oxide (Example 24 to Example 27), L-tryptophan zinc had superior dispersibility in surplus zinc oxide in the system using L-tryptophan zinc obtained by the production method of the present invention (Example 15 to Example 19), resulting in the higher Tc and the higher ΔH.

As described above, the obtained results reveals that the zinc oxide containing the amino acid zinc salt used in these Examples has superior performance as the nucleating agent to those of the compounds obtained by the related-art reaction of an amino acid and a metal oxide in an equivalent amount.

### Example 28

To 100 parts by mass of PHBH, 1 part by mass of L-Trp-Zn obtained in Synthesis Example 2 was added as the nucleating agent and the mixture was melted and kneaded at 140° C. for 5 minutes. From the obtained PHBH resin composition, about 5 mg of a sample was taken out and the crystallization behavior was evaluated with a DSC. For the evaluation, in a DSC apparatus, the sample in a molten state at 150° C. was cooled at 10° C./min. The evaluation was carried out using the temperature (Tc) at an observed exothermic peak due to crystallization and using the calorific value (ΔH) obtained from a peak area. A higher Tc value shows a higher crystallization speed and the ΔH value is an index of final crystallinity. The results are shown in Table 3.

### Comparative Example 3

The evaluation was carried out in the same manner as in Example 28 except that no nucleating agent was added. The results are also shown in Table 3.

TABLE 3

| | | Amount of | | |
|---|---|---|---|---|
| | Nucleating | nucleating agent | | |
| | agent | [part by mass] | Tc [° C.] | ΔH [J/g] |
| Example 28 | L-Trp-Zn | 1 | 83.5 | 23.9 |
| Comparative | — | — | 81.6 | 20.5 |
| Example 3 | | | | |

From the results in Table 3, it was shown that even when the poly(3-hydroxybutyrate-co-3-hydroxyhexanoate) resin was used as the crystalline resin in place of the poly(lactic acid) resin, the composition including the amino acid metal salt as the nucleating agent (Example 28) exhibited a higher Tc and a higher ΔH than those of the composition with no nucleating agent (Comparative Example 3) and had crystallization promotion effect.

### Example 29

To 100 parts by mass of PP, 1 part by mass of L-Trp-Zn obtained in Synthesis Example 2 was added as the nucleating agent and the mixture was melted and kneaded at 185° C. for 5 minutes. From the obtained PP resin composition, about 5 mg of a sample was taken out and the crystallization behavior was evaluated with a DSC. For the evaluation, in a DSC apparatus, the sample in a molten state at 200° C. was cooled at 10° C./min. The evaluation was carried out using the temperature (Tc) at an observed exothermic peak due to crystallization and using the calorific value (ΔH) obtained from a peak area. A higher Tc value shows a higher crystallization speed and the ΔH value is an index of final crystallinity. The results are shown in Table 4.

### Comparative Example 4

The evaluation was carried out in the same manner as in Example 29 except that no nucleating agent was added. The results are also shown in Table 4.

TABLE 4

| | | Amount of | | |
|---|---|---|---|---|
| | Nucleating | nucleating agent | Tc | ΔH |
| | agent | [part by mass] | [° C.] | [J/g] |
| Example 29 | L-Trp-Zn | 1 | 127.4 | 86.0 |
| Comparative Example 4 | — | — | 121.1 | 84.8 |

From the results in Table 4, it was shown that even when the polypropylene resin was used as the crystalline resin in place of the poly(lactic acid) resin, the composition including the amino acid metal salt as the nucleating agent (Example 29) exhibited a higher Tc and a higher ΔH than those of the composition with no nucleating agent (Comparative Example 4) and had crystallization promotion effect.

1. A crystalline resin composition comprising:
a crystalline resin; and
an amino acid metal salt.

2. The crystalline resin composition according to claim 1, wherein the amino acid metal salt is a metal salt of an amino acid having an aromatic group.

3. The crystalline resin composition according to claim 1, wherein the amino acid metal salt is a metal salt of an α-amino acid.

4. The crystalline resin composition according to claim 2, wherein the amino acid metal salt is a tryptophan metal salt.

5. The crystalline resin composition according to claim 1, wherein the metal species of the amino acid metal salt is at least one selected from the group consisting of lithium, sodium, potassium, magnesium, calcium, barium, aluminum, manganese, iron, cobalt, copper, nickel, zinc, silver, and tin.

6. The crystalline resin composition according to claim 5, wherein the metal species of the amino acid metal salt is zinc.

7. The crystalline resin composition according to claim 1, wherein the crystalline resin is a polyester resin.

8. The crystalline resin composition according to claim 7, wherein the crystalline resin is a poly(lactic acid) resin.

9. The crystalline resin composition according to claim 1, wherein the crystalline resin is a polyolefin resin.

10. The crystalline resin composition according to claim 9, wherein the crystalline resin is a polypropylene resin.

11. A nucleating agent for a crystalline resin, the nucleating agent comprising an amino acid metal salt.

12. The nucleating agent according to claim 11, wherein the amino acid metal salt is a metal salt of an amino acid having an aromatic group.

13. The nucleating agent according to claim 1 wherein the amino acid metal salt is a metal salt of an cc-amino acid.

14. The nucleating agent according to claim 12, wherein the amino acid metal salt is a tryptophan metal salt.

15. The nucleating agent according to claim 11, wherein the metal species of the amino acid metal salt is at least one selected from the group consisting of lithium, sodium, potassium, magnesium, calcium, barium, aluminum, manganese, iron, cobalt, copper, nickel, zinc, silver, and tin.

16. The nucleating agent according to claim 15, wherein the metal species of the amino acid metal salt is zinc.

17. A method for producing an amino acid metal salt, the method comprising reacting an amino acid (a) with a metal salt, a metal oxide, or a metal hydroxide (b) in an amount more than an equivalent amount of carboxy group of the amino acid.

18. The method according to claim 17, wherein the amino acid (a) is reacted with the metal salt, the metal oxide, or the metal hydroxide (b) in a solvent, in which the metal salt, the metal oxide, or the metal hydroxide (b) is poorly soluble.

19. The method according to claim 17, wherein the metal salt, the metal oxide, or the metal hydroxide (b) and the amino acid (a) that are reaction materials are reacted in a molar equivalent ratio of 100:0.01 to 100:90.

20. The method according to claim 17, wherein the metal species of the metal salt, the metal oxide, or the metal hydroxide (b) is zinc.

21. The method according to claim 20, wherein the metal salt, the metal oxide, or the metal hydroxide (b) is zinc oxide.

22. An amino acid metal salt composition comprising the amino acid metal salt and a surplus metal salt, a surplus metal oxide, or a surplus metal hydroxide produced by the method according to claim 17.
